(19) United States
(12) Patent Application Publication
(10) Pub. No.: US 2013/0173777 A1
(43) Pub. Date: Jul. 4, 2013

(54) Mining Execution Pattern For System Performance Diagnostics

(71) Applicants: Qiang Fu, Beijing (CN); Jianguang Lou, Beijing (CN); Qingwei Lin, Beijing (CN); Rui Ding, Beijing (CN); Dongmei Zhang, Bellevue, WA (US)

(72) Inventors: Qiang Fu, Beijing (CN); Jianguang Lou, Beijing (CN); Qingwei Lin, Beijing (CN); Rui Ding, Beijing (CN); Dongmei Zhang, Bellevue, WA (US)

(73) Assignee: Microsoft Corporation, Redmond, WA (US)

(21) Appl. No.: 13/338,530

(22) Filed: Dec. 28, 2011

(51) Int. Cl. G06F 15/173

(52) U.S. Cl. 709/224

(57) ABSTRACT

This application describes a system and method for diagnosing performance problems on a computing device or a network of computing devices. The application describes identifying common execution patterns between a plurality of execution paths being executed by a computing device or by a plurality of computing device over a network. The common execution pattern being based in part on common operations being performed by the execution paths, the commonality being independent of timing of the operations or the sequencing of the operations and individual executions paths can belong to one or more common execution patterns. Using lattice graph theory, relationships between the common execution patterns can be identified and used to diagnose performance problems on the computing device(s).

### BACKGROUND

System maintenance for computing devices and networks has become very important due to billions of users who have become accustomed to instantaneous access to Internet service systems. System administrators often use event traces which are a record of the system's transactions to diagnose system performance problems. However, the events that are really related to a specific system performance problem are usually hiding among a massive amount of non-consequential events. With the increasing scale and complexity of Internet service systems, it has become more and more difficult for software engineers and administrators to identify informative events which are really related to system performance problems for diagnosis from the huge amount of event traces. Therefore, there is a great demand for performance diagnosis techniques which can identify events related to system performance problems.

Several learning based approaches have been proposed to detect and manage system failures or problems by statistically analyzing console logs, profiles, or system measurements. For example, one approach correlates instrumentation data to performance states using metrics that are relevant to performance Service Level Objective (SLO) violations from system metrics (such as CPU usage, Memory usage, etc.). In another instance, problem signatures for computer systems are created by thresholding the values of selected computer metrics. The signatures are then used for known problem classification and diagnosis. In sum, they consider each individual system metric as a feature, analyze the correlation between SLO violations and the features so as to construct the signatures for violations, and then perform diagnosis based on the learned signatures.

### SUMMARY

This Summary is provided to introduce the simplified concepts for determining user intent over a period of time based at least in part on a decay factor that is applied to scores generated from historical user behavior. The methods and systems are described in greater detail below in the Detailed Description. This Summary is not intended to identify essential features of the claimed subject matter nor is it intended for use in determining the scope of the claimed subject matter.

This application will describe how to use extracted execution patterns performed on a computer or over a network to identify performance problem areas. A computer performs operations to complete tasks or functions on the computer or over a network. Although the tasks or functions can produce a variety of results, in some instances, the operations being executed to perform the tasks or functions may be the same operations being performed to completed different tasks or functions. Therefore, if one of the operations being performed is not performing as intended it is likely to be affecting the performance of a plurality of tasks or functions. In short, problematic operations can concurrently impact several SLO tasks or functions that use the same operations. Accordingly, identifying common or shared execution patterns across the tasks or functions can enable an administrator to identify the problematic operations more quickly than simply troubleshooting a single task or function.

In one embodiment, the common or shared execution patterns between the SLO tasks, requests, transactions, or functions can be identified to help isolate problematic operations. The common execution patterns are comprised of a plurality of operations that are common between the work process flows of the tasks or functions. The work process flows can include a plurality of modules within a computer or network in which upon the operations can be executed.

The techniques of Formal Concept Analysis (FCA) can be used to model the intrinsic relationships among the execution patterns, using a lattice graph, to provide contextual information that can be used to diagnose the performance problems of the computer or the network. For example, the most significant execution patterns can be identified using statistical analysis based at least on part on the number of requests that are performed as intended, the number of requests that are not performed as intended, the number of requests that pertain to a common execution pattern that are performed as intended, and the number of requests that pertain to a common execution pattern that do not perform as intended.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment in which a computing device performs a work flow process to be completed on the computing device or on a network.

FIGS. 2A-2D illustrates an example process that the computing device of FIG. 1 implements to determine common execution patterns among the work flow processes being performed by the computing device.

FIG. 3 illustrates an example process that the computing device of FIG. 1 performs to determine a ranking of the common execution patterns being executed on the computing device or over a network.

### DETAILED DESCRIPTION

### Overview

The techniques described above and below may be implemented in a number of ways and contexts. Several example implementations and contexts are provided with reference to the following figures, as described in more detail below. However, the following implementations and contexts are but a few of many.

### Example Environment

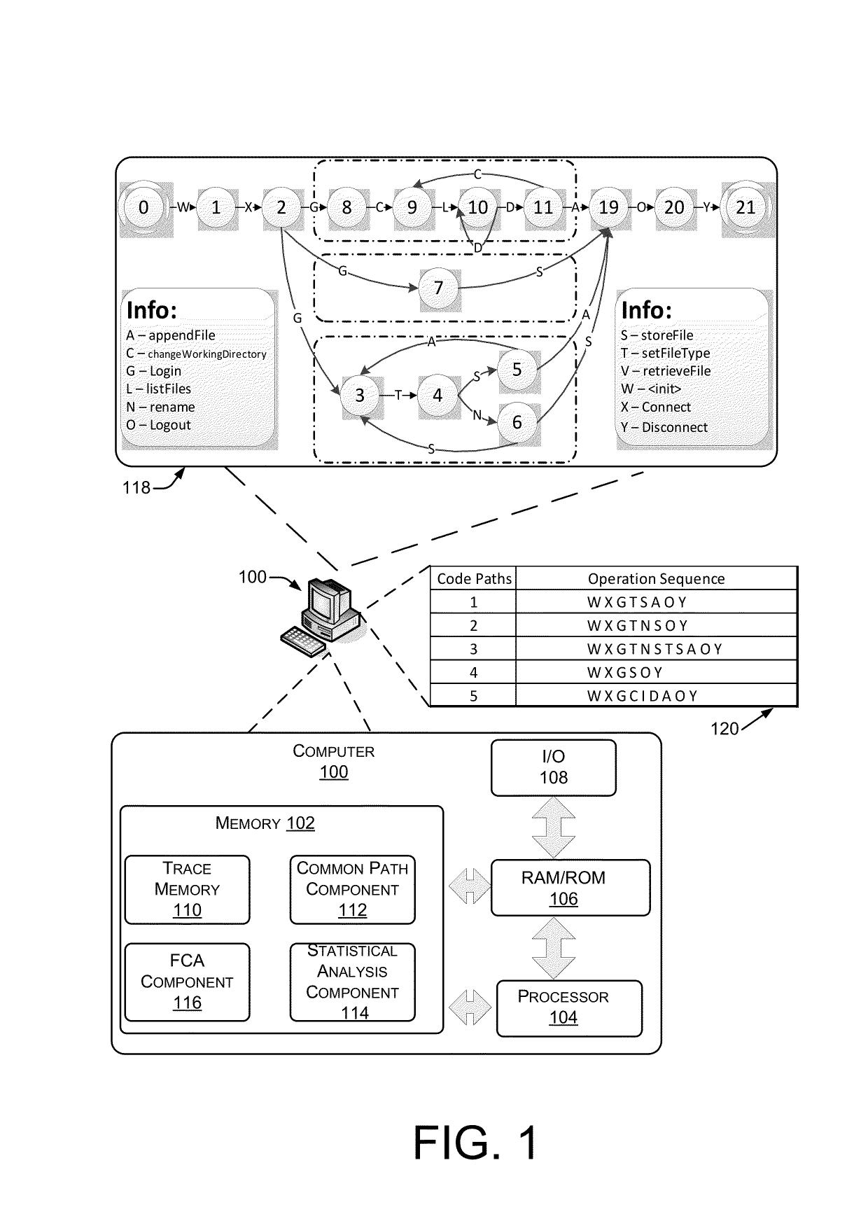

FIG. 1 illustrates an example computing device 100 that may implement the techniques described below. The example computing device 100 can be connected to a network of other computing devices and can implement requests or transactions over the network. The requests and transactions can be related to various services such as online banking, e-commerce systems, and/or email systems.

The computing device 100 can include a memory unit 102, processor 104, Random Access Memory (RAM) 106, Input/Output components 108. The memory can include any computer-readable media or device. The computer-readable media includes, at least, two types of computer-readable media namely computer storage media and communications media. Computer readable media includes volatile and non-volatile, removable and non-removable media implemented in any method or technology for storage information such as computer readable instructions, data structures, program modules, program components, or other data. Computer storage media includes, but is not limited to, RAM, ROM, EEPROM, flash memory, or other memory technology, CD-ROM, digital versatile disks (DVD), other optical storage technology, magnetic cassettes, magnetic tape, magnetic disk storage, or other magnetic storage devices, or any other non-transmission medium that can be used to store information for access by a computing device. In contrast, communication media may embody computer-readable instructions, data structures, program modules, or other data in a modulated data signal, such as carrier waves, or other transmission mechanisms. As defined herein, computer storage media does not include communication media. One of ordinary skill in the art would contemplate the techniques for executing the computer-readable instructions via the processor 106 in order to implement the techniques described herein.

Memory 102 can be used to store event trace memory 110, a common path component 112, a statistical analysis component 114, and a Formal Concept Analysis (FCA) component 116. The event trace memory 110 stores and organizes all event traces being generated by the computing device or being sent to the computing device 100 from other devices on a network (not shown). Event traces can be derived from data logs that include a time stamp, an event tag, a request ID and a detailed event message. The time stamp indicates when the event occurred, the event tag may be used to identify a corresponding event logging statement, the request ID is used to identify the current served request, and the event message describes the detailed runtime information related to processing a request. In some instances, this data described above may be embedded within data logs that include much more information than is needed to diagnose system problems. Hence, being able to extract the embedded data from a large data log and form the data into a structured representations can simplify the analysis burden.

The common path component 112 analyzes the event traces for common operations between the execution paths represented by the event traces and organizes the execution patterns into common execution pattern groups. A statistical analysis component 114 determines which of the common execution patterns are the most significant based on the number of execution paths that are performed as intended vs. the number of execution paths that are not performed as intended. The concepts related to the components described above will be discussed in greater detail below. Lastly, the I/O component 108 accepts user inputs to the computing device 100 as well sending and receiving information from other computing devices on a network (not shown).

The requests and transactions performed by the computing device 100 can be modeled generically as work process flow diagrams which include a sequence of operations being performed by one or more resources to implement a desired task or function. The tasks or functions may range from simple file management or storage on a single computer to complex information transactions over a network of computers. The transactions can be related to sending and receiving emails, banking transactions, or any other type of e-commerce transaction.

In one embodiment, a work flow diagram 118 includes a variety of modules 0-14 arranged in manner to execute task or functions using a plurality of operations illustrated as X: Connect, G: Login, Y: Disconnect, W: <init>, A: append File, S: storeFile; N: rename; V: retrieveFile; C: changeWorkingDirectory, L: listFiles, T: setFileType. The modules may include a variety of components on a single computing device or they may represent modules located on one or more computing devices connected over a network. The modules 0-14 may include various processors, memory modules, applications, or executable programs. In this embodiment, the requests and transaction being performed on the computing device are directed to a user logging in and performing several file requests and transaction prior to logging off the system. In another embodiment, the requests and transactions can be performed over a network of computing device and can include more than one user interfacing with the one or more modules included in the work flow model. Again, work flow diagram 118 is a single embodiment provided as an example to illustrate the techniques described below.

The work process model 118 can be deconstructed into a plurality of code paths 120 that represent the requests and transactions being implemented by the computing device. The code paths 120 or execution path gives a detailed picture of how a request or a transaction is served, such as, what modules are involved, and what steps or operations are executed. In many systems, recorded event traces often contain information about the request's execution paths. At least five exemplary code paths are derived from work flow diagram 118 and illustrated in a tabular format in FIG. 1. Each code path 120 represents a possible sequence of operations that is performed by the computing device 100. In this example, the code paths 120 are shown to share common or shared operations, for example each of the five code paths 120 includes the operations W, X, G, O, and Y. Although the aforementioned operations are not necessarily performed in the same exact temporal sequence in the different code paths, 120 they are still considered common to each of the code paths 120.

### Exemplary Process for Identifying Common Execution Patterns

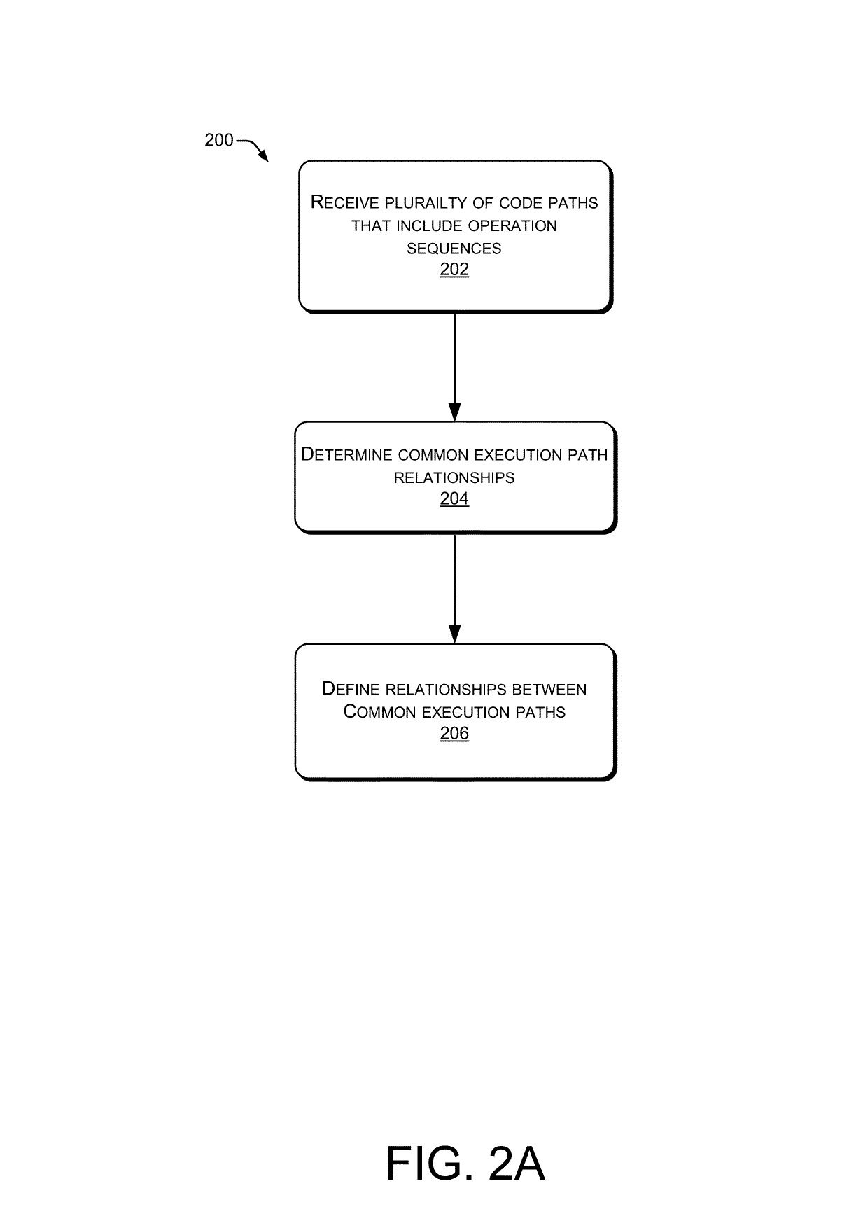

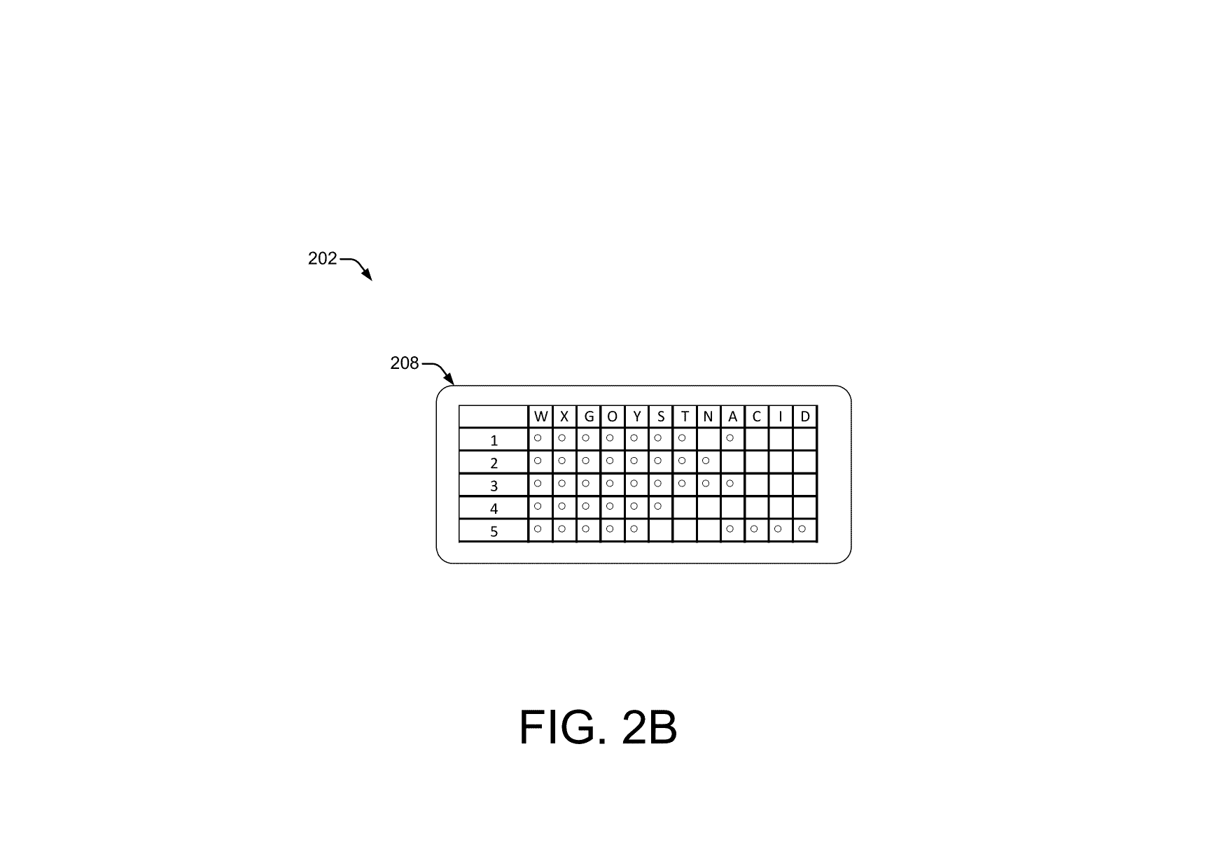

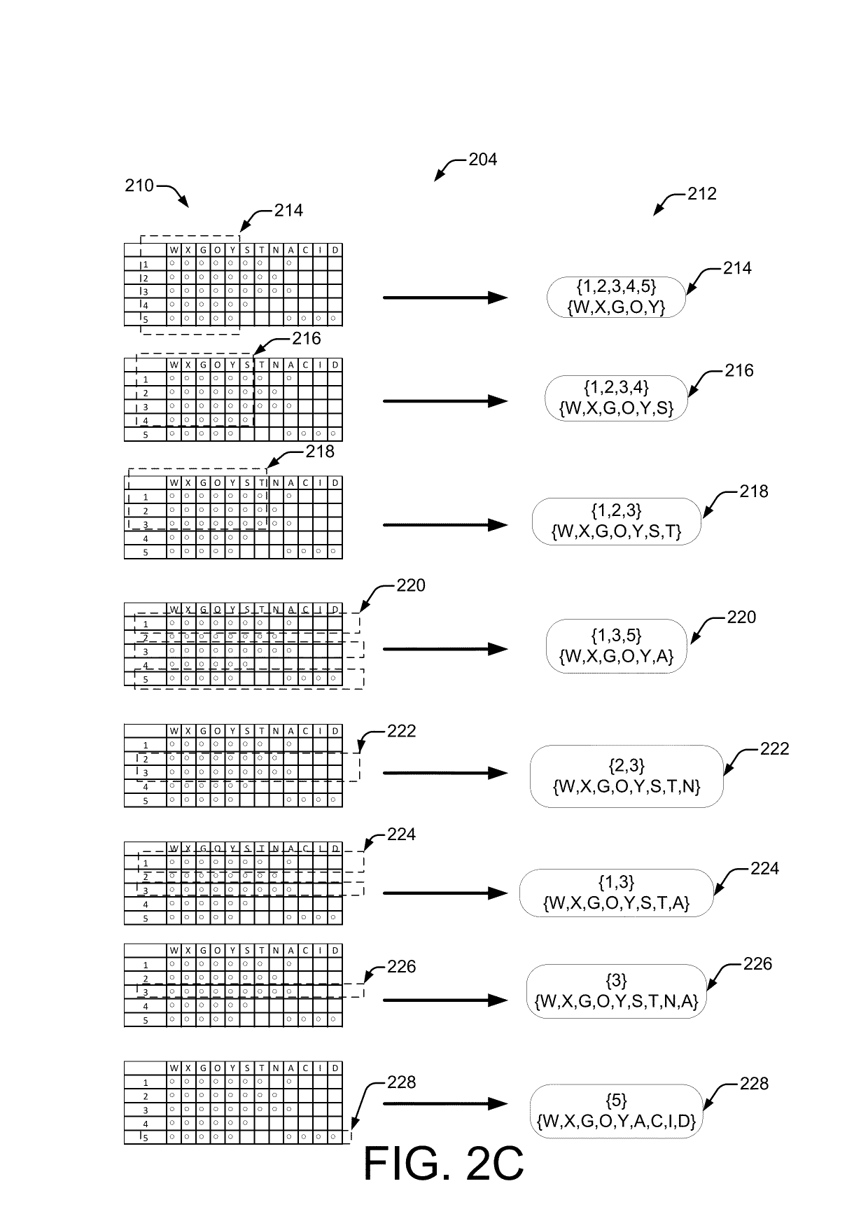

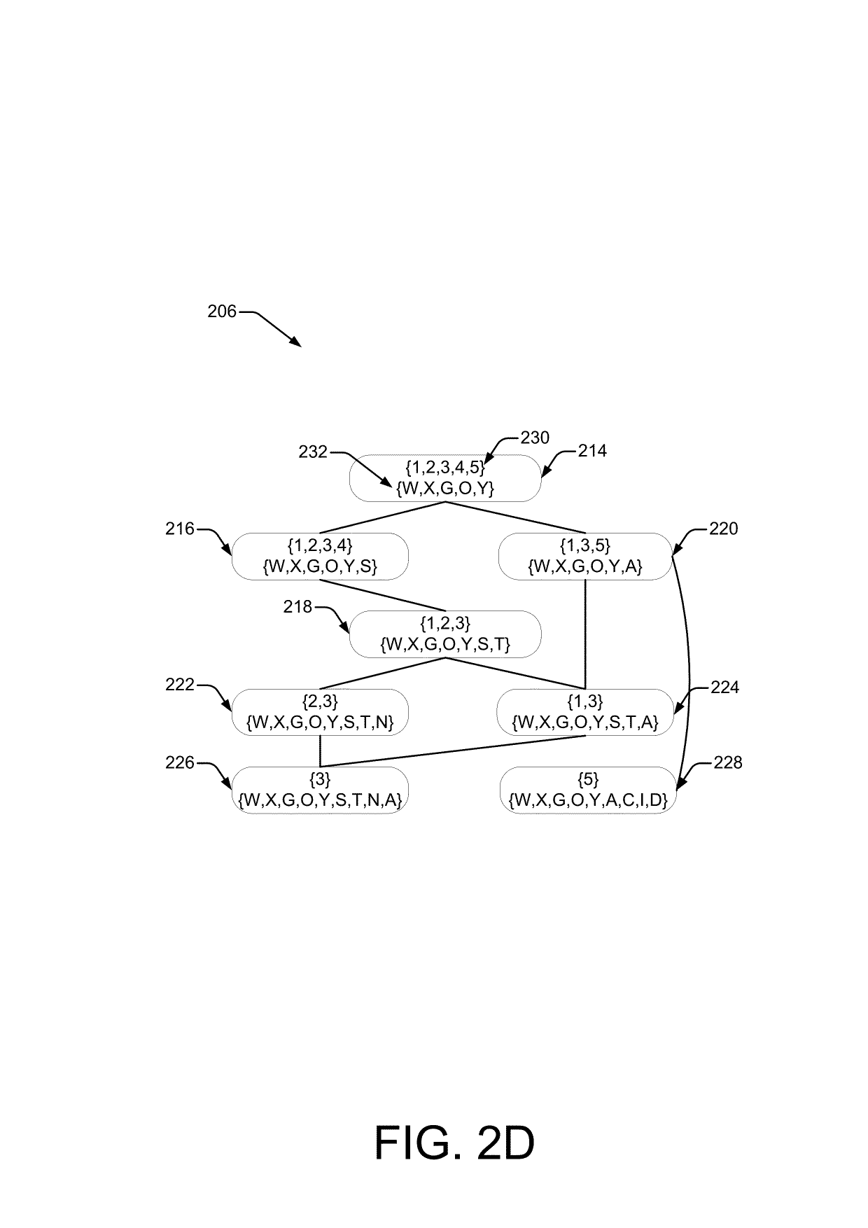

FIGS. 2A-2D illustrate a method for identifying common execution patterns and defining the relationships between the common execution patterns in a way that facilitates diagnosing system problems. The method is illustrated in its entirety in FIG. 2A and portions of the method are further described in FIGS. 2B-2D with accompanying illustrations.

FIG. 2A illustrates a process 200 for determining common execution patterns from a plurality of code paths and identifying relationships between the common execution paths. The process 200 will be described with reference to the elements described above with reference to FIG. 1.

At 202, the computing device 100 receives a plurality of code paths 120. The code paths may be extracted from event traces that are stored in the trace memory 110 of the computing device 100 and/or from event traces received from other devices over a network. In one embodiment, the common path component 112 extracts information from the event traces and organizes the data into the code path table 120.

In one embodiment, a log parsing technique automatically parses the event messages into event keys and a parameters list. Event keys correspond to the constant text string of the event print statement (e.g., event trace), therefore, it can be considered as an event tag. The parameter list may contain a request ID or some other kinds of parameters. Different parameters of different types of events may correspond to the same system variable, e.g. request ID, data block ID, etc, which are referred to as congenetic parameters. Groups of congenetic parameters can be identified in the parameters that correspond to the request ID, transaction ID or some other object identifiers.

Congenetic parameters can be automatically detected based on the following observations. For any two congenetic parameters αᵢ and αᵢ, their value sets V(αᵢ) and V(αᵢ) usually have one of the following three typical relationships.
V(αᵢ) equals to V(αᵢ). Such a relationship occurs when both events with event key L(αᵢ) and L(αᵢ) are always in the same execution code path for all request executions, e.g. W, X and Y.
V(αᵢ) belongs to V(αᵢ), i.e. V(αᵢ)⊂V(αᵢ). This occurs when the execution code paths containing L(αᵢ) is on a branch of the execution code paths containing L(αᵢ), e.g. T and G.
Or, there exists another parameter αₖ satisfying L(αᵢ)⊂L(αₖ) and L(αᵢ)⊂L(αₖ). It means that events with event key L(αᵢ) and L(αᵢ) locate at two different branches of execution code paths, while L(αₖ) locates on the common execution code path. For example, S and C are events locating at two different branch paths respectively, and G is at a common execution code path segment.

Since the number of requests is often very large, non-identifier congenetic parameters can be filtered out by largely increasing the threshold on the number of shared values of congenetic parameters.

In another embodiment, extraction of execution paths can be accomplished by developers who include event print statements in key points or the interested points in the source code so as to target specific execution paths during program execution. For example, TABLE I lists some examples of event print statements and corresponding event messages. Each event message usually consists of two different types of content: one is a constant string; the other is parameter values. The constant string of an event message describes the semantic meaning of the event. And, they are often directly designated in the event print statements and do not change under different program executions; while the parameter values are usually different under different executions. Therefore, the constant string of an event print statement, i.e. the constant part of its printed event messages, can be defined as the event key which is the signature of the event type. For example, the event key of the first event message in 0 is “JVM with ID:˜given task:˜”, where “˜” means a parameter place holder. And its parameter values are “jvm_{—}200906291359_{—}0008_r_{—}1815559152” and “attempt_{—}200906291359_{—}0008_r_{—}000 009_{—}0” respectively. After a parsing step, each event message is represented as a tuple that contains a timestamp, an event key and a parameter value list, i.e. <timestamp, event key, param₁-value, param₂-value, param_{N}-value>. For convenience, each event key has a unique index. For example, the indexes of the event keys in 0 are 161 and 73 respectively. A parameter can be uniquely identified by an event key and a position index, i.e. (event key index, position index). For example, (73,1) represents the first parameter of event key 73; and (161,2) represents the second parameter of event key 161. We should point out that (73,1) and (161,2) are two different parameters although they actually represent the same system variable (i.e. taskid). For a parameter α, we denote its corresponding event key as L(α). Each parameter, e.g. α, has a value in a specific event message whose event key is L(α). For example, the value of parameter (73,1) in the second event message in TABLE I is attempt_{—}200906291359_{—}0008_r_{—}000009_{—}0. Obviously, a parameter α may have different values in different event messages with event key L(α). The value of parameter α in a event message m with event key L(α) is denoted as v(α,m). All distinct values of parameter α in all event messages with event key L(α) form a value set of a which is denoted as V(α).

TABLE I
EVENT-PRINT STATEMENTS AND EVENT MESSAGES

| Event print statement | Event message | Index |
|---|---|---|
| LOG.info(″JVM with ID: | JVM with ID: jvm_200906291359_0008_r_1815559152 | 161 |
| ″ + jvmId + ″ given task: ″ + | given task: attempt_200906291359_0008_r_000009_0 | |
| tip.getTask( ).getTaskID( )); | | |
| LOG.info(″Adding task ′″ + | Adding task ′attempt_200906291359_0008_r_000009_0′ | 73 |
| taskid + ′″ to tip ″ + | to tip task_200906291359_0008_r_000009, for tracker | |
| tip.getTIPId( ) + ″, for | ′tracker_msramcom-pt5.fareast.corp.microsoft.com: | |
| tracker ′″ + taskTracker + ′″″); | 127.0.0.1/127.0.0.1:1505′ | |

Before calculating execution patterns, the event items produced by each request execution need to be identified so as to construct a set of distinct event keys involved in a request execution. For a single thread program, its execution logs are sequential and directly reflect the execution code paths of the program. However, most modern Internet service systems are concurrent systems that can process multiple transactions simultaneously based on the multi-threading technology. During system execution, such a system may have multiple simultaneous executing threads of control, with each thread producing events that form resulting logs. Therefore, the events produced by different request executions are usually interleaved together.

At 204, the common path component 112 can identify the common execution paths among the execution paths that are extracted or identified using the techniques described above. The differences among execution patterns are caused by different branch structures in the respective code paths. The common event tag set of two execution patterns can further be extracted to form a common or shared execution pattern. The operations are not required to be performed in the same order or same time in order for the execution paths to be grouped into a common execution pattern. An example of a common execution pattern will be described in the FIG. 2C discussion below.

At 206, the FCA component 116 implements Formal Concept Analysis (FCA) techniques against the common execution patterns to define hierarchical relationships between the common execution patterns. Formal concept analysis is a branch of lattice theory which is the study of sets of objects and provides a framework for the study of classes or ordered sets in mathematics.

Given a context I=(OS, AS, R), comprising a binary relationship R between objects (from the set OS) and attributes (from the set AS), a concept c is defined as a pair of sets (X, Y) such that:

X={oεOS|∀αεY:(o,α)εR}

Y={αεAS|∀oεX:(o,α)εR}

Here, X is called as the extent of the concept c and Y is its intent. According to the definition, a concept is a pair which includes a set of objects X with a related set of attributes Y: Y is exactly the set of attributes shared by all objects in X, and X is exactly the set of objects that have all of the attributes in Y. The choice of OS, AS, and R uniquely defines a set of concepts. Concepts are ordered by their partial relationship (noted as ≦_{R}). For example, ≦_{R} is defined as follows: (X₀, Y₀)≦_{R} (X₁, Y₁) if X₀⊂X₁. Such kind of partial ordering relationships can induce a complete lattice on concepts, called the lattice graph (also called as concept graph) which is a hierarchical graph. For two concepts, e.g. cᵢ and cⱼ, if they are directly connected with an edge and cᵢ≦_{R}cⱼ, we say that cⱼ is a parent of cᵢ, and cᵢ is a child of cⱼ. The concept with an empty object set, i.e. (Φ, AS), is a trivial concept, we call it as a zero concept. Formal concept analysis theory has developed a very efficient way to construct all concepts and the lattice graph from a given context. An example of a how relationships are created between common execution patterns will be discussed in the remarks to FIG. 2D below.

FIG. 2B is an illustration of five execution patterns 208 that have been extracted from data logs and provided to the computing device 100. Each code path or execution pattern includes a plurality of operations that that are shown in each column (e.g., W, X, G, O, Y . . . etc.). The operations are representative of a user that logs in to a computer system and conducts file management tasks. The operations are: X: Connect, G: Login, Y: Disconnect, W: <init>, A: append File, S: storeFile; N: rename; V: retrieveFile; C: changeWorkingDirectory, L: listFiles, T: setFileType. The five execution patterns 208 are arranged independently of how the operations are performed in sequence. The temporal characteristics will not dominate the determination of common execution patterns discussed below in the description of FIG. 2C below.

FIG. 2C illustrates the determining of which execution patterns form a common execution pattern as described in step 204 of process 200. FIG. 2C includes two columns the first column being the illustration table column 210 and the second being the common execution pattern column The illustration table column 210 shows which groups of five execution patterns 208 will be used to illustrate how execution patterns are grouped into the common execution patterns that are shown in the common execution pattern column 212. The process starts with the computing device 100 identifying the largest group of operations that are included in each of the paths. Next, the computing device 100 iteratively identifies the larger and larger groups of operations that are common to the execution paths. As the process iterates to larger and larger groups of operations the number of execution paths assigned to the common execution patterns diminishes.

For example, a common execution pattern 214, illustrated in column 210, shows that the code or execution paths 1-5 each include operations W, X, G, O, and Y. Accordingly, those operations and executions paths are grouped together as common execution pattern 214 shown in column 212.

Using the common execution pattern 214 as a starting point, the computing device iteratively identifies larger groups of operations that are common to one or more execution paths. For instance, a common execution pattern 216, illustrated in column 210, shows that code paths 1-4 each include operations W, X, G, O, Y, and S. Accordingly, those operations and executions paths are grouped together as common execution pattern 216 shown in column 212. A common execution pattern 218, illustrated in column 210, shows that code paths 1-3 each include operations W, X, G, O, Y, S, and T. Accordingly, those operations and executions paths are grouped together as common execution pattern 218 shown in column 212. A common execution pattern 220, illustrated in column 210, shows that code paths 1, 3, and 5 each include operations W, X, G, O, Y, and A. Accordingly, those operations and executions paths are grouped together as common execution pattern 220 shown in column 212. Common execution pattern 222, illustrated in column 210, shows that code paths 2 and 3 each include operations W, X, G, O, Y, S, T, and N. Accordingly, those operations and executions paths are grouped together as common execution pattern 222 shown in column 212. Common execution pattern 224, illustrated in column 210, shows that code paths 1 and 3 each include operations W, X, G, O, Y, S, T, and A. Accordingly, those operations and executions paths are grouped together as common execution pattern 224 shown in column 212.

The next two largest groups of operations are only shared by one execution pattern each. Common execution pattern 226 includes operations W, X, G, O, Y, S, T, N, and A. Common execution pattern 228 includes operations W, X, G, O, Y, A, I, C, and D.

FIG. 2D illustrates how the computing device 100 determines the relationships between the common execution patterns illustrated in FIG. 2C as called out in process 206.

In one embodiment, hierarchical relationships between the common execution patterns can be defined by Formal Concept Analysis (FCA). In the context of FCA theory the extent parameter is the group of execution paths 230 in the common execution patterns and the intent parameter is the group of operations 232 in the common execution patterns.

Ext(c) and Int(c) are used to denote the extent and the intent of concept c, respectively, where Int(c) is an event tagset 232, and Ext(c) is a request ID set 230. According to the FCA theory, Int(c) represents the common event tag set for processing all requests in Ext(c). On the other hand, Ext(c) represents all requests whose execution paths share the event tags in Int(c). A concept graph can be used to represent the relationships among different execution patterns. If cᵢ and cₖ are two children of cⱼ in the concept graph, we can know that the execution pattern Int(cⱼ) is a shared execution pattern which is the set of common event tags in execution pattern Int(cᵢ) and execution pattern Int(cₖ). Therefore, a fork node (the node has at least one non-zero child concept in the graph) in a lattice graph implies a branch structure in code paths since its children's execution patterns have difference. In general, although branch structures of execution paths may be nested and different branches may merge together in complex manner, the constructed lattice graph can model the branch structures and reveal intrinsic relations among different execution paths very well. Such a model can guide system operators to locate the problem causes when they are diagnosing performance problems. In practice, FCA will define a top level node that will be a common execution pattern that includes the most operations that are common to all or a majority of the nodes. In this embodiment, the top common execution pattern is pattern 214. The next level in the hierarchy is defined by the net largest common execution patterns that are most similar to the top common execution pattern 214. In this instance, the next level is defined by common execution patterns 216 and 218. The next level of the hierarchy is determined to be common execution pattern 218 which is coupled to common execution pattern 216 and not common execution pattern 218. The reason for this is that pattern 218 does not include an operation S. However, the next level of hierarchy from pattern 218 includes common execution patterns 224 and 228. Pattern 224 is also coupled to pattern 218 because they both share common operations W, X, G, O, Y, and S. Accordingly, common execution patterns can belong to multiple hierarchy levels if they share common operations with multiple common execution patterns. In this embodiment, the last hierarchy level is common execution pattern 226 which is coupled to patterns 222 and 224.

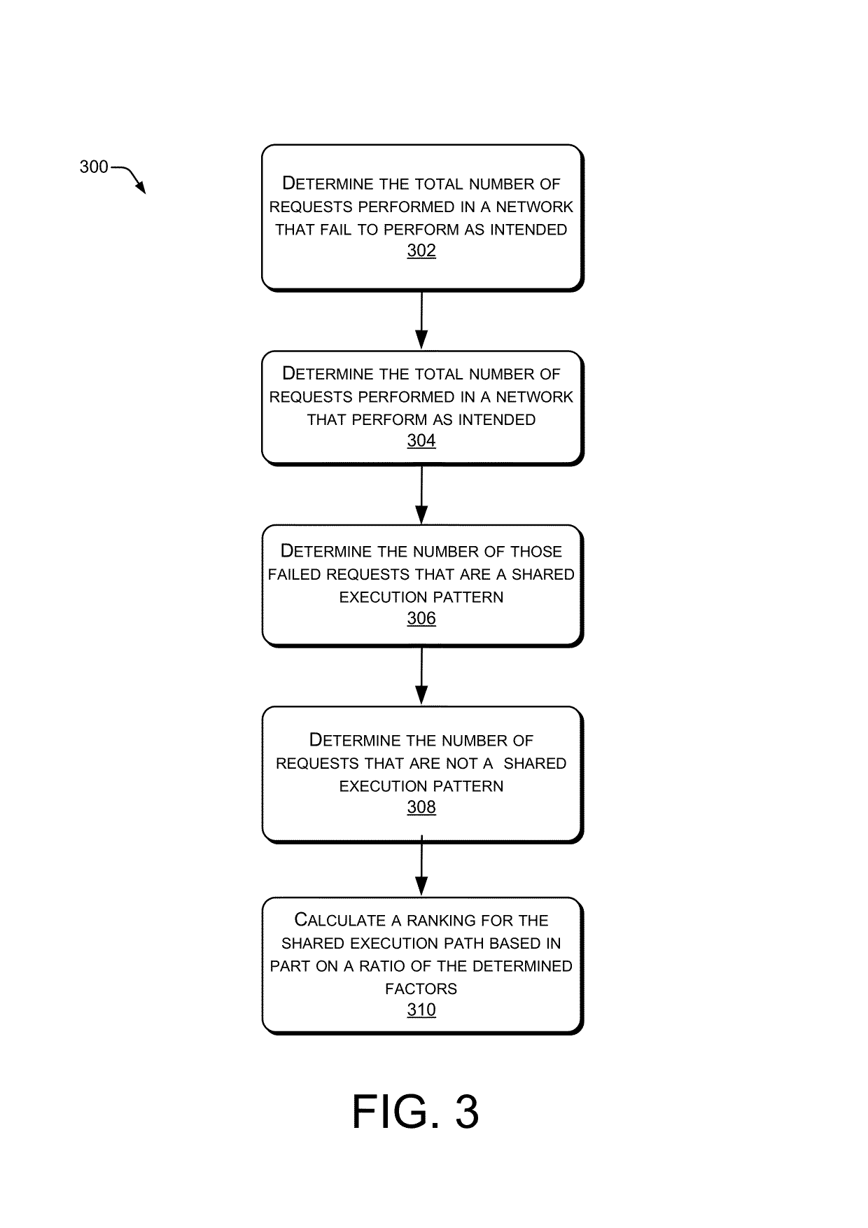

FIG. 3 illustrates a method 300 to identify the execution patterns or the common execution patterns that highly are related to performance problems of the computing device 100 or a network. Performance problems can be identified based on whether Service Level Agreement (SLA) terms have been violated. The SLA terms may include response time to queries or response time to execute a specific transaction or operation or a plurality of transactions.

At 302, the computing device 100 reviews the event traces to determine how many requests or operations were wrongly performed by the computing device 100 or a plurality of computing device over a network that were performed as intended per the SLA guidelines or by any other criteria that would constitute successful performance of an operation. In other words, how many of the operations were not successfully performed according to a set criteria.

At 304, the computing device 100 reviews the event traces to determine how many requests or operations that were performed as intended. In other words, how many of the operations were successfully performed according to a set criteria.

At 306, the computing device 100 determines how many of the failed requests included a common execution pattern.

At 308, the computing device 100 determines how many of the requests do not include a common execution pattern.

At 310, the computing device 100 calculates a ranking number for one or more of the common execution patterns based in part of the determinations made in steps 302-308. In one embodiment, the ranking number is determined by the following equation:

$$Ranking = ( \frac{{Num}_{vc}}{{Num}_{v}} + \frac{{Num}_{nn}}{{Num}_{n}} ) \div 2$$

Num_{vc} comprises the number of those failed code paths that are classified as the common execution pattern, Numₙₙ comprises the number of those code paths that were performed as intended and that are not classified as the common execution pattern, Numᵥ comprises the number of code paths performed in a network that fail to be performed as intended, and Numₙ comprises the number of code paths performed in a network that are performed as intended.

### CONCLUSION

Although the embodiments have been described in language specific to structural features and/or methodological acts, is the claims are not necessarily limited to the specific features or acts described. Rather, the specific features and acts are disclosed as illustrative forms of implementing the subject matter described in the disclosure.

What is claimed is:

1. A system comprising:
a processor that executes a plurality of execution paths comprised of a plurality of operations;
a memory that stores the execution paths; and
a common path component stored in memory that assigns execution paths to one or more common execution nodes based in part on a type of operations that are common between the execution paths.

2. The system of claim 1, wherein the execution paths comprise requests or transactions being executed on a plurality of modules on the system or a network that is in communication with the system.

3. The system of claim 2, wherein two or more of the execution paths are assigned to two or more common execution nodes.

4. The system of claim 1, further comprising:
a grouping component stored in memory that defines a plurality of relationships between the common execution nodes based in part on the type of operations common between the common execution nodes.

5. The system of claim 4, wherein the plurality of relationships is defined on a hierarchy in which a common execution node with the largest amount of execution paths is at the top of the hierarchy and one or more common execution nodes with the least amount of execution paths are at the bottom of the hierarchy.

6. The system of claim 4, wherein the plurality of relationships is defined on a hierarchy in which a common execution node with the least amount of common operations is at the top of the hierarchy and one or more common execution nodes with the greatest amount of common operations are at the bottom of the hierarchy.

7. The system of claim 6, wherein the grouping component defines one or more common execution nodes to be connected to the top common execution node in the hierarchy based in part on the one or more common execution nodes sharing a plurality of common operations and one operation that is not associated with the top common execution node.

8. The system of claim 6, wherein the grouping component defines one or more common execution nodes to be connected to the top common execution node in the hierarchy based in part on the one or more common execution nodes sharing a plurality of common operations and two operations that are not associated with the top common execution node.

9. A method comprising:
receiving a plurality of execution patterns at a computing device and storing the execution patterns in memory, the execution patterns comprising a sequence of operations that have been performed by modules on the computing device or other devices on a network;
grouping the execution patterns into one or more common execution nodes based in part the execution patterns that include a common string of operations
forming a lattice graph that comprises common execution nodes being linked to each other based in part on an amount of operations within the common execution nodes that are common to each other.

10. The method of claim 9, wherein the forming of the lattice graph further comprises:
selecting a top common execution node from the common execution nodes based in part on one of the common execution nodes comprising the least amount of operations;
linking one or more common execution nodes to the top node based on the common execution nodes having a minimum amount of difference an amount of operations or types of operations in the top node and the common execution nodes, the linking of the one or more common execution nodes being a first plurality of nodes; and
linking one or more nodes of the common execution nodes to the one or more nodes of the first plurality of nodes based in part on the common execution nodes having a minimum amount of difference in an amount of operations or types of operations between the one or more first plurality of nodes and the common execution nodes, the nodes being linked to the first plurality of nodes being a second plurality of nodes.

11. The method of claim 10, further comprising:
linking another common execution node to one or more of the first plurality of common execution nodes or the one or more of the second plurality of common execution nodes based in part on the other common execution node comprising a plurality of operations that are similar to the operations in the first or second plurality of nodes.

12. The method of claim 9, wherein the receiving of execution patterns comprises extracting request level event traces from the computing device or the devices on the network.

13. The method of claim 9, wherein the receiving of execution patterns comprises extracting transaction level event traces from the computing device or the devices on the network.

14. The method of claim 9, further comprising evaluating one or more execution patterns to determine a ranking of how much the one or more execution patterns impact the computing device or the network.

15. The method of claim 9, wherein the sequence of operations are determined based in part on a non-temporal characteristic.

16. A method comprising:
determining a number of code paths performed in a network or a computing device that fail to be performed as intended, each code path comprising a plurality of operations being performed on the network or a computing device;
determining a number of code paths performed on the network that are performed as intended;
determining a number of those failed code paths that are classified as a common execution pattern;
determining a number of those failed code paths that are not classified as the common execution pattern; and
calculating a ranking of the share execution pattern, using a processor, based in part on:
the number of code paths performed in the network that fail to be performed as intended;
the number of code paths performed in the network that are performed as intended;
the number of those failed code paths that are classified as the common execution pattern; and
the number of those code paths that were performed as intended and that are not classified as the common execution pattern.

17. The method of claim 16, further comprising:
determining a number of those failed code paths that are classified as another common execution pattern;
determining a number of those failed code paths that are not classified as the other common execution pattern; and
calculate a ranking of the other share execution pattern, using a processor, based in part on:
the number of code paths performed in a network that fail to be performed as intended;
the number of code paths performed in a network that are performed as intended;
the number of those failed code paths that are classified as the other common execution pattern; and
the number of those failed code paths that were performed as intended and that are not classified as the other common execution pattern.

18. The method of claim 16, wherein the calculating the ranking is determined by the following equation:
$$Ranking = ( \frac{{Num}_{vc}}{{Num}_{v}} + \frac{{Num}_{nn}}{{Num}_{n }} ) \div 2 ,$$
wherein:
Num_{vc} comprises the number of those failed code paths that are classified as the common execution pattern;
Numₙₙ comprises the number of those code paths that were performed as intended and that are not classified as the common execution pattern;
Numᵥ comprises the number of code paths performed in a network that fail to be performed as intended; and
Numₙ comprises the number of code paths performed in a network that are performed as intended.

19. The method of claim 16, wherein the common execution pattern is based in part on types of operations that are common between the execution paths.

20. The method of claim 19, wherein the common execution pattern if further based on non-temporal characteristics of the operations.
